(19) United States
(12) Patent Application Publication
(10) Pub. No.: US 2017/0228847 A1
(43) Pub. Date: Aug. 10, 2017

(54) METHOD FOR HIRING OUT A TRANSPORTATION MEANS SUITABLE FOR TRANSPORTING GOODS, AND TRANSPORTATION MEANS

(71) Applicant: Martin EBERLEIN, Kammeltal (DE)

(72) Inventor: Martin EBERLEIN, Kammeltal (DE)

(21) Appl. No.: 15/501,588

(22) PCT Filed: Jul. 21, 2015
(86) PCT No.: PCT/DE2015/000369

§ 371 Date: Feb. 3, 2017

(30) Foreign Application Priority Data
Aug. 5, 2014 (DE) 10 2014 011 707.3
Aug. 5, 2014 (DE) 10 2014 011 708.1
Jan. 7, 2015 (DE) 10 2015 000 135.3
Mar. 7, 2015 (DE) 10 2015 002 934.7
Jun. 25, 2015 (DE) 10 2015 008 181.0

(51) Int. Cl. G06Q 50/30; G06Q 20/12; G06Q 10/08; G06Q 10/06

(52) U.S. Cl. CPC G06Q 50/30; G06Q 10/06315; G06Q 20/12; G06Q 10/087; G06Q 10/0635

(57) ABSTRACT

A method for hiring out transportation means for transporting goods, wherein, at a depot, at least one transportation means is provided for use and return. Each transportation means has a detection means. The user of a transportation means carries a mobile communication device. The method uses at least one motivator to motivate the user to return the transportation means. Before return of the transportation means to the depot, the mobile communication device and the transportation means are associated by using a detection means in a first detection process and identifiers of the mobile communication device and the transportation means, which are linked, are stored by at least one computer system. Upon return of the transportation means, a second detection process is done. Data obtained by the two detection processes are used by the at least one computer system to allow the use of the at least one motivator.

The invention relates to a method for hiring out a transportation means suitable for transporting goods, in which, at a return point, at least one transportation means is provided for use and subsequent return, each transportation means having an identification means, the user of a transportation means carrying with him a mobile communication device, the method using at least one motivator which is intended to impart to the user that the return of the transportation means used is advantageous, wherein, before return of the transportation means to the return site, the mobile communication device and the transportation means are associated by using the identification means in a first detection process and identifiers of the mobile communication device and the transportation means, which are assigned to one another, are stored by making use of at least one computer system, and wherein, upon return of the transportation means, a second detection process is carried out and the data obtained by the two detection processes are at least used by the at least one computer system to allow the use of the at least one motivator.

The invention further relates to a transport means for carrying out the method.

A method of this kind is described in the document EP 1 285 412 B1. The document reveals a method for detecting and rewarding the return of shopping carts to provided return points of a retail store, wherein, during shopping a first signal A and during return of a shopping cart to a return point a second signal B is generated, and wherein the two signals A and B are correlated for release of a bonus. The document proposes that the first signal A, which is generated during shopping, is assigned to a certain customer by identifying and individualising the customer prior to generating the first signal and/or by the customer carrying the generated signal A with him on an information storage device until it is correlated with the second signal B. Furthermore the document reveals that simultaneously the identity of the shopping cart used for shopping can be detected.

The document DE 10 2013 101 022 B3 proposes a dispensing station for portable or mobile goods containers, which can be coupled up to the dispensing station, the containers having an individual container identifier and being dispensable from the dispensing station by entering an individual user identifier of the user. In the process and in response to the release of a goods container by the user, the container identifier is associated to the user identifier and in response of a repeated coupling up of the goods container to the dispensing station and based on the assignment of container identifier and user identifier, a bonus value is updated for the completed shopping and a deposit value is updated for the goods container.

Both solutions avoid coin locks commonly mounted on shopping carts, described for example in the document EP 1 358 637 B1. This however requires the return points or dispensing stations to be equipped with electronically controlled means requiring electricity. Due to the disadvantages to be expected installations suitable for carrying out both methods have not been built until today.

Solutions as described in the documents U.S. Pat. No. 3,882,982 A, U.S. Pat. No. 3,897,863 A, and WO 98/51197 are afflicted with the same disadvantages.

For carrying out detection processes using detection means on identification means and for assigning and recording identifiers the prior art uses computer systems and data connections between these systems.

Proceeding from this prior art, it is the object of the invention to develop a method described at the beginning of this document in such way that coin locks mounted on transportation means are made redundant and that at the return points no additional means requiring electricity are needed.

The method to be developed shall furthermore serve as a basis for a range of additional applications, which are expedient and advantageous
for use of transportation means during a shopping process,
for use of transportation means for delivery of goods, and
for fleet management of transportation means.

It is furthermore an object of the invention to develop transportation means in such way that they can be used for the method to be developed.

The solution of the object relating to the method is described in the characterising part of claim 1.

The solution of the object relating to the transportation means is described in claim 33.

The decisive advantage of the developed solutions is explained by five facts.

Firstly, the mobile communication device is used as carrier of electrical energy and replaces so far common data processing and/or data transmitting means located at return points.

Secondly, it is made possible to equip each transportation means with a simple identification means requiring no electricity which can be read out through a wireless data connection.

Thirdly, the availability of computer systems, for example in the form of payment devices or checkout systems, provided by the operator or the transportation means and at the intended use locations of the transportation means can be taken for granted.

Fourth, as described extensively hereinafter, the method is suitable for determining the arrangement of transportation means in rows or stacks using the second and third detection processes.

Fifth, the second and third detection processes are performed by the mobile communication device and therefore by the user, so that the user can terminate an interaction between the mobile communication device and the transportation means, which is desired only during use of the transportation means, and restore his privacy. Anyway available mobile communication devices of the users only need to be equipped with an application software for carrying out the method. The commonly available at least one computer system only needs to be equipped with a server software suitable for carrying out the method and the transportation means only needs to be equipped with a simple identification means requiring no electricity in order to make carrying out the method feasible.

Thus the proposed solutions achieve in an advantageous manner an interconnection of known technical means in such way, that a most simple, technically non-challenging method can be realised, which requires no coin locks and no upgrade of return points with electrical and/or electronic means. The mobile communication device, which usually is owned by the user, now decisively determines the whole take-and-return process of the transportation means. Essential in the spirit of the invention are the second and third detection processes, both being carried out during the return process.

The invention therefore not only makes securing means and equipping return points with stationary detection means unnecessary but also electronic equipment attached to transportation means. The savings achieved by that are considerable.

The following description of the invention describes further advantages relating to additional useful application possibilities. The process steps proposed in the characterising part of claim 1 serve as a basis for carrying out the method and all further embodiments.

The method uses at least the following components:
multiple transportation means equipped with identification means;
one or more return points, where the transportation means are provided for use and subsequent return;
per user of a transportation means a mobile communication device equipped with an application software for carrying out the method;
at least one computer system equipped with a server software for carrying out the method.

Further, for certain embodiments the method optionally uses the following technical components:
for each transportation means a use location defined by location data for intended use of the transport means;
per user a price detection means;
a payment processing device;
a means of payment per user;
per user an AR system, i.e. augmented reality system.

Use locations for transportation means suitable for transporting goods are particularly retail stores, for example self-service stores, department stores, shopping malls, airports, or railway stations, as well as warehouses and goods handling facilities. Businesses producing or maintaining transportation means are as well suitable use locations for carrying out the method.

The term transportation means comprises all not motorised, mobile, portable or by hand movable devices. Such transportation means are in particular shopping carts, transport trolleys in garden centres and DIY stores, shopping baskets, as well as luggage trolleys having a goods carrying container. The term transportation means further comprises devices intended for supply of goods, i.e. roll cages.

Users of transportation means are therefore customers of retail stores as well as personnel of retail stores, goods suppliers of retail stores, or suppliers supplying and maintaining transportation means. Hereinafter, the customer is called the user.

A return point is any collection point where transportation means are provided for use. Such collection points are common in particular in self-service stores, at railway stations or at airports.

Identification means are understood to be all means suitable for identifying an object carrying the identification means and for distinguishing the object from objects of the same kind, in particular in the form of printed symbol codes, barcodes, QR-Codes, as well as data carrying means such as transponders. Identifiers are understood to be characteristics enabling such distinguishing, for example serial numbers or individual codes. Within the scope of the invention the following types of identification means are advantageous:

A first type is a component visibly different for each transportation means, for example a serial number plate.

A second type is a machine readable memory of same or different kind carrying for each transportation means different data, for example a NFC Tag.

A third type is a plate, a card or a sticker with printed QR code or barcode with properties of the two prior mentioned types.

A fourth type, if detected by a mobile communication device preferably used as price detection means, causes an individual identifier to be assigned to the transportation means until it has been returned at a return point. In case of the fourth type ist is necessary that all transportation means are permanently equipped with different identification means since the distinctness results from assignment of individual identifiers. Such an assignment is feasible using an application software of the mobile communication device or using a computer system which exchanges data with the mobile communication device. The advantage of the fourth type are lower costs for the identification means, since identifiers of the same kind can be used, which can be made in serial production. Since price detection means and mobile communication devices use software licensed with serial numbers and since these devices set up data connections using IP addresses or telephone numbers, price detection means and mobile communication devices are distinguishable from other devices of the same kind, so that their identifier is suitable for being assigned to a transportation means in order to make a transportation means distinguishable from other transportation means. For use of the fourth type it is advisable that the mobile communication device is located on the transportation means, for example using a holder.

A fifth type is an identification means based on a plurality of different identifiers of mobile communication devices preferably used as price detection means and a plurality of different identifiers of a number of transport means.

A sixth type of identification means utilises the fact that, in the return process of transportation means at return points, a transportation means returned by the user takes, in relation to the user and the users mobile communication device, a different position and is moved differently from a transportation means located at the return point or the return point itself. The sixth type consists of physical components of the borrowed transportation means. The other identification means located at the return point consists of physical components of at least the returned transportation means and the process of return, this means it firstly consists of a pattern serving detection of the transportation means, which is detected if the transportation means is partially or fully located in a space section detected by the mobile communication device, and it secondly consists of a pattern, which is determined by position change of the partially or fully detected transportation means towards the partially or fully detected return point or towards at least one other, partially or fully detected transportation means located at the return point. Detection of movement related to the return point or related to a transportation means located at the return point implies detection of the return point or detection of a transportation means located at the return point, wherein any parts or features of the return point or of a transportation means located at the return point are identification means enabling detection of movement related to the return point.

Combinations of the prior mentioned identification means are described by the term ,identification means' as well.

The process of detecting an identification means using detection means depends on the type of identification means. This results in the following application possibilities:
a visual or acoustic machine detection of identification means and/or movement of identification means, in particular using a camera, a movement sensor, a radar or using ultrasound signals or
a machine reading of data, in particular using RFID tags and readers, using bluetooth or NFC technology, using internet connections, telephone connection, or other data connections or
machine data exchange, in particular using RFID tags and readers, using bluetooth or NFC technology, using internet connections, telephone connections, or other data connections.

Mobile communication devices owned by the user are known in the form of mobile phones, smart phones, tablets, smart watches, data glasses, and the like, and in the form of combinations of this kind of devices instead of single devices. In order to be suitable for the proposed method, these mobile communication devices are at least able to
detect the identification means intended to be detected;
record detected patterns, symbols or data in the form of data;
send and receive data using wireless data connections.

In order to be able to set up and terminate data connections and in order to send and receive data using data connections, mobile communication devices need to be individually identifiable in the net, in particular an individual telephone number and/or IP address being used for this. Individual identifiability in turn supports a unique association implemented by programming technology with any device.

Price detection means are in particular known under the term “handheld scanner”. These as well are able to
detect the identification means intended to be detected;
record detected patterns, symbols or data in the form of data;
send and receive data using wireless data connections.

Price detection means which are carried by the customer are also mobile communication devices.

A computer system is either hardware, software, a combination of hardware and software, and/or implemented software. A computer system for example can be a process implemented on a processor, a processor, an implementable object, a sequence of commands, a software, and/or a computer. An application implemented on a server as well as the server itself are examples of computer systems. Likewise mobile communication devices as well as software implemented on mobile communication devices are computer systems. A computer system can be located in a single process and/or in a sequence of implemented commands or in one computer or divided to several computers.

The at least one computer system is at least suitable to save identifiers of mobile communication devices and of transportation means, to assign them to one another, to terminate these assignments and/or delete data relating to identifiers and assignments of identifiers and to update such data. The at least one computer system, providing offline functionality, can be present in the mobile communication device and/or in the payment processing device and/or as a separate device which can be independent from the location of the transportation means. According to certain embodiments of the inventive method the computer system can also be suitable to carry out the saving, assignment, cancelation of assignment, and deletion of
personal data;
data relating to motivators;
data relating to goods and prices of goods;
data relating to a shopping process;
data relating to borrowing and return of transportation means;
data relating to transportation means and their properties;
data relating to return points and their properties;
location data;
other data used for implementing the method.

A computer system is also a payment processing device if the system is used to cash up goods, deposits and/or bonuses, or other monetary benefits or liabilities.

A payment processing device is a device suitable for
accepting means of payment in the form of data or computer systems such as credit cards or payback cards;
implementing payments and credits using at least one means of payment and using data processing;
cashing up, i.e. saving data relating to payments and credits and transmitting these data to a database.

Payment processing devices can be checkout terminals accepting cash and printing cash receipts as well as computer systems implementing payments in the form of data processing. Likewise payback portals or payback stations, where customers can print transactions or bonuses using payback cards are payment processing devices. It is important for implementing the method that the payment processing device is able, either directly or using a data transmitting device, to communicate with a price detection device and/or mobile communication device as is known from practice in particular by self-scanning checkouts, or checkouts accepting payment with smartphones. Suitable combinations of the prior mentioned devices, for example a combination of a self-scanning checkout accepting a handheld scanner as price detection means and a payback portal, which communicates with the mobile communication device, are in total termed ,payment processing device' in the spirit of the invention. As described in the document US 2015 100016777 A1 relating to FIG. 66i, payment processing devices and means of payment can also be realised using augmented reality, for example by a ,virtual display'. Means of payment used for payment with a payment processing device exist as computer system in case of payment with a mobile communication device.

It is known that computer systems can set up, maintain, and terminate data connections to other computer systems. This is assumed as prior art for implementing detection, accounting and payment operations of the inventive method.

Wireless data connections which are possible between prior mentioned technical components serve either mutual communication or unilateral reading of data, for example in the case of scanning a barcode. A wireless data connection may imply that data during transmission are not digital data but exist as data coding patterns and are translated into digital format only by the reading device. For implementation of the method are for example used
a first wireless data connection for carrying out the first detection process;
a second wireless data connection for carrying out the second detection process;
a third wireless data connection for carrying out the third detection process;
a fourth wireless data connection between the mobile communication device of the user and a computer system, and optionally
a fifth wireless data connection between a price detection means and a payment processing device, for example of a retail store;
additional data connections between communicating devices used for carrying out the method.

Such data connections can be continual so that the first and the second data connection can be the same.

The distinctness of the first and second detection process can be achieved in case of a continual first and second data connection respectively a continual detection of the transportation means, by a process step carried out during continual detection, for example payment of goods with the mobile communication device, which defines a point in time at which the first detection process segues into the second detection process. Without such a process step it can be determined by implemented software that at a certain period of time after the beginning of the first detection process the segue into the second detection process occurs. It can further be determined by implemented software that during carrying out the third detection process the segue from the first detection process into the second detection process occurs. The distinctness of the second and third detection process is given by the fact that the object of the detection process and/or the time of the detection process is different. The method therefore can be implemented with a whole range of equivalent embodiments, all of which are characterised by the distinctness of the first, second, and third detection process.

One data connection may imply that a data connection, for example due to a transmission error, terminates and is set up again, or if one transmission channel is replaced by several channels or if same data are transmitted more than once. Then mentioned data connections can optionally be set up by customers and/or triggered automatically by any means, for example the limit of a spatial distance being undercut.

For carrying out the detection processes detection means are used which are suitable for detection of identification means, such as barcode scanners, NFC readers, QR code reading smartphones, pattern recognition devices and the like.

For carrying out the first detection process in particular three detection means are available from prior art, which are suitable to detect and associate one another identifiers of the transport means and the mobile communication device.

A first option uses any devices of a retail store as detection means, for example using Apple's iBeacon, an entry gate, or a payment processing device.

A second option instead uses a price detection means intended for detecting prices of goods and available to the user, for example a handheld scanner.

A third option uses the mobile communication device as a detection means. Carrying out the first detection process with the mobile communication device is particularly advantageous, since this saves the expenditure for a device of the retail store or expenditure for a handheld scanner.

Since the price detection means given by the retail store to the customer is a mobile communication device as well, the second option is technically equivalent to the third option. Whenever hereinafter it is referred to a mobile communication device relating to the first detection process, then this shall apply for the equivalent solution of a price detection means provided to the user as well. The other way around there is an option to use the mobile communication device as a price detection means.

In order to motivate the return of a transportation means as a suitable means at least one motivator is used. A motivator according to the invention is a device and/or method which motivates the desired action. The motivator can be made effective using technical means in order to motivate the desired action and, after the desired action has been carried out or as a consequence of the desired action being carried out, can again be made ineffective using technical means.

The invention uses motivators in such way that as a consequence of the second and third detection processes, which both follow after the first detection process, at least one motivator becomes ineffective. Preferably the at least one motivator becomes effective by the first detection process and becomes assigned to the transportation means and the mobile communication device of the customer. The following motivators can be chosen from:
a first motivator formed by identifiers of the mobile communication device of the user and of the transportation means assigned to one another. The first motivator becomes effective by the assignment and becomes ineffective by cancelation of the assignment.
a second motivator formed by a deposit value, known from the use of coin locks. The second motivator becomes effective by debit of the deposit value and becomes ineffective by credit of the prior debited deposit value.
a third motivator formed by a reward, for example a bonus as proposed in the document EP 1 285 412 B1. The third motivator becomes effective by assignment of the mobile communication device and a transportation means and becomes ineffective by cancelation of the assignment in conjunction with a reward.
a fourth motivator being a computer system formed by the mobile communication device and being intended for use during shopping. The computer system is being activated by the first detection process and is being deactivated by the second and third detection processes. The fourth motivator unfolds its effectiveness in particular if a user, for example a customer, wants to use a function or a system of the mobile communication device during shopping and at the same time wants the function to become impossible or the system deactivated upon shopping being finished and the transportation means being returned.
a fifth motivator is formed by stored data intended for economic exploitation by the user of the transportation means i.e. the customer of the retail store. The fifth motivator becomes effective by generating and storing economically useful data and becomes ineffective by transmitting the data to an addressee and the economic exploitation associated with this. Triggered by the first detection process and during the shopping process data relating to the shopping process and/or the purchased goods are stored in the mobile communication device and in the process are locked against transmittal. By the second and third detection processes the locking is terminated and transmittal of the data using a data connection is made possible. In case the shopping is done with the mobile communication device of the user as a price detection means and/or the user pays with the mobile communication device, the data are saved in the mobile communication device and can be used as a motivator.

A sixth motivator is formed by updating a user interface of the mobile communication device as a consequence of the carried out first detection process such, that information relating to the intended use of the transportation means is made available to the user whereby the subsequent second and third detection processes undo the update and/or cause another update and/or enable another update.

Examples for information relating to the use of transportation means are
technical and safety information, orders, recommendations, or warnings relating to the transportation means or the transport of goods;
offers relating to offered goods, goods prices and terms, shopping lists, and the like;
information enabling communication between manufacturer of goods and/or retailer and/or user.

A particularly advantageous embodiment of the sixth motivator is that as a consequence of the carried out first detection process it is shown to the customer of the retail store, which goods or categories of goods, product brands, as well as pricing offers are available in the retail store at this point of time. In turn it is advantageous in this case if an option is provided to the customer to pre-select such information such that only goods or categories of goods, product brands, as well as pricing offers desired by the customer are displayed. Firstly this has the consequence that the user receives information which the user wants to use here and now, and secondly that relevance to the customer and thus a high degree of attention is guaranteed to the advertising retailer or manufacturer of a brand. In order to be able to use the motivator in such way that the return of a transportation means seems advantageous to the user, it is for example possible
to let the re-availability of this information display during a repeated implementation of the method, i.e. a repeated shopping process, depend on the termination of the information display by the second and third identification processes, and/or utilisation of displayed offers, for example discounts, depend on the second and third detection processes and/or
to let utilisation of displayed offers, for example a discount, depend on carrying out the second and third detection processes and/or
deletion or anonymisation of personal data, which were generated or made available as a result of the first detection process, be achieved by the second and third detection processes and/or
to send a message identifying the user and notifying loss or potential loss of the transportation means to the retail store if the mentioned functions and benefits have been utilised and the second and third detection processes have not been carried out or have not been carried out within a pre-set period of time.

Combinations of the prior mentioned six motivators as well as additional motivators are possible. Relating to the use of motivators the invention offers a range of advantageous variants:
a first variant is, using a user interface, to display that a motivator becomes effective or becomes ineffective;
a second variant is to let a motivator become ineffective only if the second and third data connection is set up simultaneously or within a pre-set period of time;
a third variant is to let a motivator become ineffective only if goods detected by a price detection means are considered to be paid and optionally if a borrowed price detection means is considered to have been returned;
a fourth variant is that only by detection of a transportation means and/or by a motivator becoming effective and/or by saving of data relating to a deposit value stored in a price detection means, an operation modus for detection of goods prices and/or for payment of goods is produced and that this operation modus is terminated by the second and third detection processes;
a fifth variant is that, using a deposit value as motivator, debits and credits of deposit values are saved to an account made with means of software in the mobile communication device until, using the fifth wireless data connection between the mobile communication device and a payment processing device, data of a deposit value or of deposit values are transmitted one by one, as a sum, or as a balance to the payment processing device and a deposit value or deposit values or the balance of several deposit value debits and credits are debited or credited to the customer by the payment processing device;
a sixth variant is that by the first and/or second and/or third detection process transmission of location data and/or time data of the mobile communication device to a computer system is arranged or terminated. Location data are suitable to enable multimedia or augmented reality systems relating to location which enhance shopping experience or enable shopping. Upon completion of shopping, however, a user certainly does not want his location to be tracked by the retailer using location data. Yet the retailer is interested to be able to track location data of the user until the second and third detection processes have taken place. Optionally, if a user leaves the premises of the retail store and if the second and third detection processes have not taken place, a notification of the user can be initiated in order to remind the user and prompt the user to return his transportation means to a return point.
a seventh variant is that with the mobile communication device and the transportation means a goods receiving device is formed such that the mobile communication device detects goods and movement of goods relating to the transportation means and wherein the system of the goods receiving device is dissolved by the second and third detection processes;
an eighth variant is that as a consequence of the first detection process a computer system of the retail store and a computer system of the mobile communication device interact in such way that components, data, and computing power of the respective other system are accessed, in particular the computer system of the retail store accessing the camera of the mobile communication device and/or a payment means, which is present in the mobile communication device, as well as the mobile communication device accessing data and computing power of the computer system of the retail store, wherein the interaction is deactivated by the second and third detection processes.

The seventh and eighth variants can be advantageously combined such that, starting with or during the first detection process, the mobile communication device continuously detects the transportation means, that during the continuous detection the mobile communication device maintains a wireless data connection to the payment processing device, thereby a wireless controllable payment means of the customer being detected by the payment processing device, and that when taking or returning goods the taking and returning action is detected by the goods receiving device, which is formed with the mobile communication device and the transportation means, in such way that the update of a monetary value of the payment means is caused.

Access to the camera or data of the camera, access to a payment means, to personal data, to security codes, and the like can be desired during shopping in order to enable price detection of goods or data exchange with a payment processing device. However, advantageously for the effectiveness of the motivator the user has an interest that this motivator becomes ineffective at termination of the shopping process, in particular access to data saved in the mobile communication device, the camera or payment means.

By forming a goods receiving device the invention widens the function of price detection to a function of pattern recognition relating to taking and returning goods, wherein not only goods and prices of goods but in particular movement patterns of the detected goods relating to the transportation means are detected. Accessing the camera or data of the camera of the mobile communication device and using the data connection set up between the mobile communication device and the payment processing device, the actual pattern recognition can be carried out by a data processing unit of the retailer intended for this purpose. This advantageously saves computing power and thus power consumption of the mobile communication device and it ensures that the pattern recognition always relates to current range of goods and price information, which is owned by the retailer and not by the user. Using a wireless data connection the mobile communication device receives data from the pattern recognition device and/or sends data generated by the mobile communication device and supporting the pattern recognition device to at least one pattern recognition device, wherein optionally a user interface of the mobile communication device is updated.
a ninth variant is that the payment processing device carries out payment of goods only after the first detection process has been carried out and carries out payment of goods only before the second and third detection processes have been carried out;
a tenth variant is that caused by the second the third detection processes an AR system, which supports or enables purchase of goods, is being deactivated.
an eleventh variant is that caused by the second and third detection processes and using a data connection between the mobile communication device and the at least one computer system an identifier of the transportation means and either the identifier of another transportation means or the identifier of an identification means located at the return point is being transmitted, that the at least one computer system checks the transmitted identifiers using inventory data relating to transportation means located at at least one return point and that the computer system makes ineffective a previously effective motivator if during checking one of the two identifiers were found in the inventory data and the respective other identifier was not found in the inventory data. This enables
a twelfth variant consisting in that the ineffectiveness of a previously effective motivator is being caused only if the transportation means detected during the first detection process is being detected again during the second detection process.

It is worthwhile noting that in particular the forth variant solves a problem of spacial and temporal limitation known under the term “geo-fencing” without recourse to geo-information such as GPS or Apple's iBeacon. The shopping process including all software of the price detection means and/or the mobile communication device relating to the shopping process starts with the use of the transportation means and ends with the return of it and thus, as desired, spacially limited to the retail store.

In its most simple embodiment the method only uses the first motivator. In particular for implementation of the method by goods suppliers of retail stores or by staff members or service providers taking care of fleet management, the first motivator can be sufficient, while additional motivators are appropriate to be applied with users of retail stores.

In a preferred embodiment the invention makes both the customer-unfriendly deposit value and the bonus value, which is expensive for the retailer, redundant and replaces both with the fourth and/or fifth and/or sixth motivator, which offer to the retailer a variety of effective embodiments, which at the same time are attractive for the customer. Then there exists an option for the operator of numerous retail stores to use the fourth and/or fifth and/or sixth motivator in all stores and in addition the second motivator only at locations where the fourth and/or fifth and/or sixth motivator turn out not be effective enough, such as in locations with a high theft rate. Likewise, the third motivator can play a complementary role. There exists the possibility of a user-specific selection and structuring of motivators, for example charging of a deposit value only with users not reliably returning transportation means to return points or reward with a bonus only if children visit the retail store or if a transportation means which has been lost is being returned to the retail store. The selection and structuring of motivators can be made dependent on other arbitrary factors. In order to let the mentioned motivators be effective without use of mechanical means of security, detection of the return of the transportation means is necessary.

Transportation means movable on wheels, for example shopping carts, when being returned are horizontally stacked into transportation means located at the return point from behind, not the other way round. In this way stacks of transportation means returned to return points are formed. Forming stacks, transportation means in the form of hand baskets are vertically stacked into hand baskets located at the return point from top, not the other way round. A transportation means “b” located at the return point and a transportation means “a” stacked into it and returned to the return point form an ordered pair <a, b>. Thus by the second and third detection processes data of such an ordered pair are created. Since the identification means of the returned transportation means has priorly been detected by the first detection process, it is defined which identification means corresponds to the “a” and which identification means corresponds to the “b” of the ordered pair even if the second detection process and the third detection process are carried out in any order. When using transportation means and repeatedly carrying out the method, numerous data sets of ordered pairs are generated. Again, from these data the sequence of transportation means in a row can be determined, resulting in always current inventory data. Provided <a, b> being a first ordered pair, <a′, b′> being a second ordered pair, and b=a′, it follows from this that the sequence is a, b, b′.

In such way using the second and third detection processes inventory data of transportation means located at at least one return point can be continuously updated such that the computer system can distinguish between a transportation means being returned and a transportation means being located at the return point, in this case refer to the prior mentioned advantageous eleventh and twelfth variant for using motivators. If there is no transportation means located at a return point or at a section of the return point intended for forming a row, then no transportation means “b” located at the return point is available for forming the ordered pair <a, b> and the problem of starting a row needs to be solved.

It is a known problem in self-service stores that customers prefer returning transportation means to already long rows since the route is then shortest for the customer. Due to this, long rows become even longer and short rows become even shorter.

According to a first solution to the problem of starting a row and analogous to row docking stations equipped with a key chain for shopping carts equipped with coin locks, the return point is equipped with an identification means such that this identification means replaces the identification means of a transportation means located at the return point for forming the ordered pair <a, b>. A returned transportation means being at the position intended for starting a row, the preferred position of a stationary identification means of the return point relating to the identification means of the returned transportation means is identical to the relative position of two identification means of a pair of transportation means being stacked exhibiting the intended nesting increment defined by the design of the transportation means. According to a second solution to the problem of starting a row, the second and third detection processes are carried out on the identification means of the returned transportation means, wherein using location data and/or inventory data of transportation means located at at least one return point are being determined, wherein optionally the user of the mobile communications device is requested by means of a user interface to report or confirm the starting of a row, and wherein inventory data are updated by data coding the start of a row. Carrying out the second and third detection processes on the same identification means as a signal coding the start of a row causes the ineffectiveness of a previously effective motivator.

A possible improper implementation of this second solution is carrying out the second and third detection processes not at a return point but at an arbitrary different location. A possible erroneous implementation is carrying out the second and third detection processes on the identification means of the returned transportation means even though there are already transportation means at a return point. In order to solve the object of the invention and in order to provide the signal coding the start of a row only if a transportation means has been returned to a return point and thereby no transportation means was available at the return point or at a section of the return point intended for forming a row, use of location data and inventory data as well as confirmation by the user is advantageous.

A process step advantageous in this context is that the computer system causes the ineffectiveness of a previously effective motivator only if there is no undercutting of a minimum number of transportation means and/or no exceeding of a maximum number of transportation means in a row of stacked transportation means having been subjected to the second and third detection processes. A suitable motivator is rewarding the replenishing of a row being shorter than a minimum length. A first consequence of this is that the problem of starting a row hardly occurs anymore and a second consequence is that the length of rows is effectively curbed. Since the number of transportation means in a retail store is nearly constant and since the inventory at return points varies only in the amount of transportation means having being taken, a motivator suits well which motivates replenishing short rows in order to curb the length of rows. This advantageously takes place dynamically, that is without having to determine explicitly and having to achieve with technical means a maximum length. Alternatively to the dynamic curbing of row length it is possible that the computer system saves the second and third detection processes only if according to inventory data a maximum row length ist not exceeded.

The solution to the problem of starting a row only using identification means of the transportation means enables a stack of transportation means characterised in that, for each transportation means located at the return point and being part of a stack, the spacially next identification means located at the return point is located on a transportation means which is spacially next within the stack, and characterised in that all identification means intended for the second and third detection processes are located on transportation means being part of the stack.

Such a stack advantageously makes it possible to carry out the second and third detection processes in such way that the user actively carries out only the second or the third detection process and that the carried out detection process automatically causes the respective other detection process to be carried out. For example, carrying out a first detection process on an identification means formed by a QR code or a barcode can cause the mobile communication device to carry out another detection process on a identification means formed as RFID tag being within reach. Hereby, shortest possible and in particular standardised nesting increments are advantageous.

Solving the problem of starting a row using only the identification means of a single transportation means opens up another application of the invention. From practice and prior art a method is known according to which an owner of a mobile communication device who finds a transportation means, which was lost by a retail store, at an arbitrary location outside the premises of the retail store, takes a photo of the transportation means and sends this photo, providing geo data as well, to the store or a service provider. It is common that such a notification is being rewarded in particular if hereby the store gets back the lost transportation means. In comparison to this prior art the invention considerably improves anti-theft protection and reclaiming lost transportation means.

A first improvement is that instead of taking photos the first detection process is carried out and that the transportation means individualised by the identification means is assigned to the mobile communication device by the computer system. A second improvement is that it is known to the computer system which user or which mobile communication device most recently can be assigned to a first, second, and/or third detection process on the identification means and at what most recent time the transportation means was detected as existing in the inventory. The last user of the transportation means is most likely responsible for the loss of the transportation means. In particular, if the loss of a transportation means correlates more than once with a last use by a certain customer, the suspicion is reinforced. The retail store can then respond with taking individualised measures to secure transportation means. The method enables automatisation of this reaction by individualised use of motivators, for example debiting a user-specific deposit value or by a message to the user using a user interface of the mobile communication device. A third improvement is that this user-specific behaviour control and inventory control serves as an effective motivator to return transportation means to return points and at the same time serves as, compared to prior art, improved motivator to return lost transportation means to retail stores. A third improvement is that in the process of return of a lost transportation means carrying out the second and third identification processes causes the lost transportation means to be booked into the inventory of the store again. Advantageously not only the retailer or a service provider, but everyone having a suitable mobile communication device can trigger this booking. A fourth improvement is achieved by the additional process step of sending location data to the computer system. Suitable location data are in particular GPS data of the mobile communication device.

As a consequence of carrying out the first detection process, a transportation means is detected as lost by the computer system if location data transmitted by the mobile communication device to the computer system do not the match intended use location, wherein the computer system, in case of non-matching location data, sends a message to the mobile communication device and communicates which use location is intended for the transportation means. In this way scanning of the identification means can within seconds result in the display of a retail store address on the mobile communication device. Another additional process step is that using a user interface of the mobile communication device a choice is offered that either the finder wants to return the lost transportation means to the retail store by himself or with help of a third person or that the finder leaves that to the store or a service provider of the store.

In case of return of lost transportation means as well as in case of return of transportation means used for a shopping process the possibility exists to carry out the first detection process with a first mobile communication device and to carry out the second and third detection processes with a second mobile communication device. For example, the first detection process can be carried out using a price detection means, which is provided to the user by the store, wherein a price detection means in particular may be a handheld scanner or an AR system, and that the user carries out the second and third detection processes with his own mobile communication device. In order to have an effective motivator, in this case it is necessary that the first mobile communication device and the second mobile communication device are assigned to one another. If this is the case, carrying out the method with two or more mobile communication devices is equivalent to carrying out the method with only one mobile communication device. Assignment to one another can be achieved using software. If, for example, a user registers with his mobile communication device for borrowing a handheld scanner serving as price detection means and if the customer carries out the first detection process with the handheld scanner and the second and third detection processes with his mobile communication device, then an unambiguous assignment is achieved by the registration. The means of an assignment to one another permits carrying out the method with arbitrary changing and changeable devices.

The method can be carried out with the mentioned types of identification means and respectively matching detection technologies and detection means as well as with suitable future identification means and detection technologies.

The freedom to choose identification means, detection technologies and detection means allows advantageously to adapt the method to new retail set-ups and to new methods of selling goods, such as the shopping experience enhanced by Augmented Reality as described in the document US 2015 0016777 A1. The described AR system is firstly worn at the head of the customer and exchanges data with other devices in order to generate virtual elements relating to the real environment and actions of the customer. Due to these properties it is a mobile communication device. Acc. to section [0657] of the mentioned document the AR system enables a shopping experience further described by examples in sections [0657] to [0657]. In section [0661] the document describes the detection of a transportation means or a hand on a transportation means as a means of triggering an automatic start of applications of the AR system. One of the mentioned applications acc. to section [0657] is a coupon or discount displayed by the AR system, the detection of gestures by the AR system, as well as acc. to section [0657] termination of shopping using a virtual checkout display with no need for a physically present payment means. The document does not provide hints for properties of a transportation means or a method for borrowing a transportation means intended for a shopping process. The present invention fills this gap.

The described detection of a transportation means or a hand on a transportation means is suitable as a first detection means only if the AR system and the transportation means can be assigned to one another, thus requiring an identification means detected by the AR system. If due to identical look of transportation means of a retail store the AR system cannot distinguish a transportation means selected by the user from other transportation means located in the retail store, then an automatic start of applications of the AR system can be triggered by detection of any transportation means but these applications cannot be assigned to the transportation means selected by the user. For safety and practicality of using an AR system this assignment is hardly dispensable. According to section [0657] the shopping ends by using a virtual display and thus payment of the goods, not by returning a transportation means at a return point. However, if the assignment of the AR system and a particular transportation means, which is advantageous for the safety and practicality of the use of an AR system, is implemented and stored to a computer system, then this assignment needs to be canceled again at the end of the shopping process. If this happens during payment of goods, then return of the transportation means is still an unsolved problem. Whereas payment processing devices, including virtual ones, suitably are placed in space regions controlled by retail security devices and personnel of the retail store, return points for transportation means are preferably located near to parking spaces of the users, so that the merging of payment processing devices and return points is at best an option for small stores only. The invention advantageously makes it possible to pay for the goods during or at the end of shopping and complete the shopping process only with return of the transportation means.

The invention, when using a database, that is a system for describing, saving, and recovering of big amounts of data, opens the door to further expedient applications relating to the here present subject and application field. Data generated by carrying out the method can be saved to and analysed by a computer system, for example in order to
control parameters of the method such as motivators or pre-set periods of time, and/or
obtain user profiles relating to the user and/or the transportation means and/or the price detection means, and/or
generate economic data relating to the transportation means and/or the price detection means, in particular concerning frequency and extent of use, concerning selection of transportation means and price detection means by users or user groups, as well as for each transportation means and for each price detection means individually a cost/benefit relation, and/or
update inventory data of transportation means and/or price detection means and in order to update such inventory data not only per each retail store, but per each return point or each row of transportation means at a return point, and/or
cause the user by means of a user interface of the price detection means and/or the mobile communication device to use a particular payment processing device, and/or
by means of a user interface of the price detection means and/or the mobile communication device to return the price detection means and/or the transportation means at a certain location and/or detect certain identification means located at the return point in order to achieve a limitation of row length and thus a more equal distribution of transportation means at return points, and/or
provide saved data not only to the retail store but firstly to users and secondly to service providers taking care of delivery and maintenance of price detection means and of transportation means as well as of implementation of the method, in order to control deliveries, maintenance, installation and configuration of price detection means, transportation means, and additional methods by means of detected user requirements, and/or
determine for several stores of one or more operating companies the extent of use of transportation means, in particular number of shopping processes, duration of shopping processes, selection of transportation means, and in order to aggregate this information and provide it to interested parties, in particular to the retailers themselves.

The inventive method can exemplarily be described in more detail by means of embodiments. As a basis for all embodiments serve the process steps
according to which a third detection process is carried out;
according to which a second and a third detection process are carried out only by the mobile communication device;
according to which the second detection process is carried out on a returned transportation means and the third detection process is carried out on an identification means located at the return point, whereby both detection means may as well be carried out in reverse order, and
according to which caused by a combination of second and third detection processes the assignment to one another of the mobile communication device and the transportation means is canceled using a computer system.

By termination of the assignment to one another of the mobile communication device and the transportation means another assignment by means of the first detection process and therefore another implementation of the method is made possible. The cancelation of the assignment is achieved by update of data, whereby the data to be replaced by updated data can either be deleted or archived or changed or in any other way be made distinguishable from the updated data. In particular the cancelation of the assignment takes place in such way that a previously effective motivator can become ineffective.

As a consequence of the carried out second and third detection processes and using at least one computer system the at least one previously effective motivator therefore becomes ineffective and data relating to positions of stacked transportations means in a row stored by the computer system are updated.

According to an exemplary first embodiment the user takes a transportation means from a return point. In the retail store however the user decides not to shop and wants to leave the store. The retail store offers for this purpose a gate which opens as soon as the first detection process has been carried out. The user uses his mobile communication device for carrying out the first detection process and the gate opens. Arriving at the return point the user nests the transportation means into a stack and, subsequent to the carried out first detection process, carries out the second and third detection processes with the mobile communication device. At the space region contained by a gate, the retail store preferably performs a visual control of the transportation means. If thereby goods are detected, then the user is requested to pay for them. Queueing at a checkout without having shopped becomes unnecessary.

According to an exemplary second embodiment the price detection means and the mobile communication device are two separate devices. The user enters the retail store and takes a transportation means from a return point. Subsequently, the user receives from the retail store a price detection means, whereby data of the user such as name, address, customer code, phone number of the mobile communication device, credit card number, or the like have been saved to a database of the retail store which are suitable to assign to one another the price detection means of the user and his mobile communication device until the price detection means is returned. For this purpose the user identifies himself for example with the phone number of the mobile communication device and/or a secret code in order to borrow a price detection means which then is assigned to the user respective his mobile communication device until it is returned. If later on during the shopping process a data connection between the price detection means and the payment processing device of the retail store, serving as the computer system in this case, is set up, then by this assignment data of the user are known to the payment processing device and can be used to charge the user the full price of the purchased goods.

After the user has received the price detection means, the user takes care that the price detection means detects the identification means of the transportation means used by the user and for this purpose carries out the first detection process. The price detection means detects the transportation means provided to the user, in this case preferably by means of a wireless data connection between the price detection means and an identification means of the transportation means. The already achieved unambiguous assignment of the price detection means and the mobile communication device and the now produced assignment of the transportation means and the price detection means result in an unambiguous assignment to one another of the mobile communication device and the identification means. The relations are transitive and symmetric.

By detection of the transportation means effectiveness of a motivator is caused, in this case for example debiting a deposit value, whereby it is not relevant if the price detection means generates the deposit value and transmits it using a data connection to the payment processing device exemplarily used as computer system or if the deposit value is generated by the payment processing device using transmitted data. Relevant is that the deposit value is assigned to the transportation means and the mobile communication device. During shopping in the store the user uses the price detection means for scanning the purchased goods with the consequence of detecting the individual goods prices. Using a wireless data connection firstly data for billing the goods detected by the price detection means and secondly data for billing the deposit value are transmitted to the payment processing device and are stored there. After settlement the user returns the price detection means. An account of the user is debited firstly with the total value the purchased goods and secondly with the deposit value. As long as the deposit value was debited to the account of the user it is irrelevant if the total value of goods and deposit value is charged to the same account or is charged to different accounts, if additional debiting or crediting occur, or if no total value of goods is debited because the user did not purchase anything. Thus there exists another advantageous possibility to debit a credit card account with the total value of goods and to debit a payment means or account installed in the mobile communication device with the deposit value. This idea presents itself because in case of repeated shopping repeated debit and credit of deposit value occurs and it allows the store to provide a first deposit value free of charge to the user. A preferred solution is using a payback account, bonus point account, or membership account of the user for debiting and crediting the deposit value, since this achieves customer loyalty and independence from payment service providers and their fees.

The fifth wireless data connection between the price detection means and the payment processing device, if not already existing during the shopping process and the scanning of purchased goods, at latest is set up when returning the price detection means at a payment processing device, so that at latest now the data of detected prices and goods together with data for identifying the price detection means and the identification means of the transportation means are transmitted to a payment processing device.

Arriving at the return point the user sets up the second wireless data connection between his mobile communication device and the identification means of the transportation means used by him. In addition, if not happening automatically, he sets up a third wireless data connection between his mobile communication device and an identification means located at the return point.

Instead of the second and third data connections there can be optionally and equivalently a machine visual or acoustic recognition of the respective identification means, for example using data glasses as a mobile communication device.

By detection of an identification means located on a transportation means and detection of another identification means located at the return point, a wireless data connection is set up to the payment processing device either autonomously by the mobile communication device or by the user using an user interface of the mobile communication device, which serves as proof for the carried out return of the transportation means, whereby subsequently the wireless data connection is terminated either by the mobile communication device or by the payment processing device, having the consequence that the assignment to one another of the identifiers of the mobile communication device and the transportation device is terminated and that the previously effective motivator becomes ineffective, here for example that the payment processing device credits a previously debited deposit value. Thereby, the mobile communication device is detected by the payment processing device by telephone number, IP address, or otherwise, so that for the credit the existing unambiguous assignment of the returned transportation means, the deposit value, the mobile communication device, the user, and the account of the user can be used. With settlement of the credit the previously set up data connection is terminated by the system, whereby optionally between the settlement of the credit and the disconnecting of the previously set up fourth wireless data connection either a pre-set period of time or a transmittal of data from the mobile communication device to the payment processing device is provided. Terminating the first, second, third, and fifth data connection happens in the course of the method as soon as these data connections are not needed anymore for carrying out the method, in any case at latest when the fourth data connection is terminated. Data connections are not needed anymore once the data to be transmitted by them are transmitted.

For setting up the fourth data connection two options exist:

According to a first option the mobile communication device communicates over a spatial distance between the return point and the payment processing device and thus sets up the fourth data connection over this distance.

According to a second option the deposit value firstly gets credited to an account locally set up in the mobile communication device, for example as function of a mobile shopping app, and the communication with the payment processing device for settlement with another account and thus the set up of the fourth data connection happens at a later time. The second option utilises the fact that in case of repeated correct implementation of the method by the user debit and credit of deposit values alternate and cancel out, so that the occasional settlement of a balance with a payback account, a bonus point account, or a membership account of the user is sufficient. The balance may be settled when a user for example at a portal of the retail store wants to get paid out or use an amount he is entitled to receive from a payback, bonus point, or membership program. In this case the fourth data connection ist set up only when the balance is to be settled and can therefore a connection over short distance, for example NFC or Bluetooth, may be used to a payback portal or a checkout counter.

When the second and third data connections are set up or an alternative visual or acoustic recognition takes place, the returned transportation means in any case is located again at the return point and is available for use by a subsequent user, also in case that the fourth data connection according to the second option is not being set up during every shopping process.

According to an exemplary third embodiment the price detection means is the mobile communication device of the user, with a software having the function of a price detection means installed on it. The user carries out the first, second, and third detection process by means of his mobile communication device.

Software providing the function of a price detection means are known as mobile shopping app, which provides the option to enlarge the scope of functions of existing software for implementation of the method. Different from the second embodiment, the user does not borrow a price detection means and does not need to return it at a payment processing device. However, the same transitive and symmetric relations exist as a means for assigning to one another the price detection means, mobile communication device and transportation means. According to the third embodiment the mobile communication device is used for detecting the identification means of the transportation means, for scanning of goods and detection of prices of the goods and for payment of goods at a payment processing device. The process steps carried out with the mobile communication device according to the second embodiment are the same.

According to the first, second and third embodiment options exist to make the method particularly user-friendly and secure. It is a common feature of these options that by the first detection process, in any case at latest in advance of the second and third detection process a motivator becomes effective and is assigned to the transportation means and/or the mobile communication device of the user.

In the description so far it was assumed that the fourth, fifth, and possibly more data connections can be set up and terminated at any time. However, the method to a high degree possesses an advantageous offline functionality, which is in particular achieved by linking data generated by the first, second, and third detection process with time data. The computer system can receive the data at an arbitrary later point of time and can still sort them in a timely order such that the function is preserved to the extent not needed in real time by the user. Motivators exist which can be used with a time delay and the update of inventory data by the computer system is not needed in real time as well.

An important advantage of the offline functionality is that, following the detection of the identification means, the customer does not need to wait until mobile communication device and computer system have exchanged data. The mobile communication device therefore can display success of the detection process immediately after it has been carried out. It follows from this advantageous offline functionality that the mobile communication device displays to the user the success of the detection process before the mobile communication device could have been informed by means of data exchange with the computer system, with which status of use, that is, either borrowed and in use or returned, the identifier detected by the first detection process is linked to in the data of the computer system. From this it follows that in case of offline functionality the success message needs to be the same regardless of which status of use the identifier is linked to and that by the first detection process in any case an update of the previous status of use to the status of use of a borrowed transportation means takes place.

The first and second embodiment implements the method with retail set-ups commonplace today. The third embodiment exemplarily described in the following uses more recent technologies.

The user takes a transportation means from a return point. He carries an AR system serving as a mobile communication device, preferably data glasses, for example Google Glass or Microsoft Hololens, or optionally another device, for example a tablet or a smartphone. In case of using data glasses, the identification means of the transportation means is detected by the AR system by the user looking at the transportation means so that the first detection process is being carried out. The identifier of the transportation means is now stored to a computer system of the AR system and the AR system and the transportation means are assigned to one another. This assignment causes the computer system of the AR system to set up a secure data connection to the payment processing device of the retail store. Optionally this secure data connection can be set up when the AR system during entering the store receives another signal, for example from an iBeacon set up. Optionally by the first detection process a software key is generated which activates a security set up in such way that access to the retail store or a space section of the retail store is granted to the user, wherein the key at latest and in order to end the shopping process is deleted by the second and third detection processes. The set up of the secure data connection may, increasing security, occur only after the user has entered the retail store or a space section of the retail store using the key. Set up of the data connection between the AR system and the payment processing device causes the computer system of the AR system, to activate functions of the AR system and optionally deactivate other functions such that the AR system becomes a price detection means. In the operating status of a price detection means the payment processing device preferably has access to the camera and/or data of the camera and to a payment means of the user and automatically raises security settings for the AR system to a standard required for a secure payment process. For example, access to insecure websites or the start of insecure applications may be blocked.

The AR system and the transportation means form a goods receiving device such that the AR system detects the transportation means as intended for acceptance of goods and continuously detects movement of goods relating to the transportation means and/or the AR system. After the first detection process and before the second and third detection processes the mobile communication device detects with a fourth detection process goods and with a fifth detection process movement of goods relating to the transportation means, wherein by the fifth detection process at least one movement pattern is detected such that the debit of the goods price using a payment means of the customer takes place and wherein by the second and third detection processes the fourth and fifth detection processes are made impossible.

The fourth detection process may optionally be triggered only when the user looks at the goods and takes them into his hands. By means of pattern recognition and/or identification means of the goods the goods are detected by the AR system. The actual pattern recognition requiring high computing power preferably is performed by the computer system of the store or a service provider of the store, saving electrical power of the AR system and always using current data relating to goods and prices. By means of the data connection to the payment processing device, data generated by the AR system for pattern recognition are transmitted to the computer system of the retail store and the computer system serving as a pattern recognition device causes the AR system to display to the user at least the detection of the goods.

With the fifth detection process the AR system detects movement of detected goods related to the transportation means which is assigned to the AR system. By means of movement the AR system detects a shopping process. Movement of goods into a basket of a transportation means formed by a shopping cart may code for the purchase of goods and cause debit of the goods prices using a payment means of the user. In the same way movement of goods out of the basket may code for the return of goods and cause a credit of a previously debited price of goods. Other movements may for example make information relating to the product visible by means of the AR system or allow users to provide feedback to the retail store.

When movement is detected which does not correspond to a pattern coded for the fifth detection process, for example taking of goods, which are not received by the transportation means and/or return of goods which does not start with taking of a transportation means at a return point respective the first detection process, then means of security are activated.

In particular if a checkout zone is removed in the store and payment of goods is intended to take place when taking the goods, it is advantageous, when taking of goods or the return of goods by the user is detected with the fourth and fifth detection process, to activate security means if a payment means of the user is not detected.

The user thus carries out only activities, which need to be carried out anyway, in particular movement of goods onto a platform or into a basket of the transportation means. The goods are now already paid for. Without passing through a checkout zone the user leaves the store with the purchased goods. Carrying out the second and third detection process at the return point cancels the assignment to one another of the transportation means and the AR system, ends the access of the payment processing device to the computer system of the AR system and ends the operating status as a price detection means. This process uses the fourth motivator. Finally also the fifth motivator is used. The AR system presents to the user related options, among others selling shopping-related data relating to a market research institute as well as notification of the identifier of the transportation means to a service provider, who has leased the fleet of transportation means to the retail store. The user uses, while receiving suitable benefits, these options and informs the service provider that he was not satisfied with the transportation means. The service provider uses this information during the next regular maintenance of the transportation means.

Based on the mentioned process steps additional expedient process steps can be noted, in particular if the retail store has a highly automated facility for dispensing goods and at least one pattern recognition device is formed with the mobile communication device preferably being an AR system.

Another process step may be that by an improper return of goods and/or packaging or placement of goods at another place of the facility for dispensing goods detected by the at least one pattern recognition device activates at least one set up securing the goods and/or persons in order to indicate improper behaviour of persons.

Another advantageous process step may be that the payment processing device carries out payment of the goods with a payment means if previously the payment means has been debited with a deposit value for using the transportation means or if another motivator is effective.

Furthermore it should be noted that the payment processing device may preferably process the payment of goods with a payment means only if previously the mobile communication device and the payment processing device have detected the identification means of the transportation means used for the shopping process.

Within the scope of the invention it is furthermore possible that the payment processing device credits a deposit value only or grants advantages of a motivator only if the mobile communication device has carried out the second and third detection processes by means of a pattern recognition device.

The described method extended to all aspects of a shopping process, starting from taking of a transportation means and ending with its return, can also be carried out, because the mobile communication device receives data with means of a data connection from the at least one pattern recognition device and/or sends data supporting the pattern recognition device and generated by the mobile communication device to the at least one pattern recognition device, whereby optionally and using these data an user interface of the mobile communication device is updated.

The function of pattern recognition devices, which are required here, are described in an extensive literature belonging to prior art, among others in “Christopher M. Bishop, Pattern Recognition And Machine Learning”, ISBN-10: 0-387-31073-8. Hereby in the known manner, the technical process of recognising objects implicates generation of data, which map properties respective patterns of detected objects in such way, that it is possible to exclusively extrapolate the existence of the object from the presence of these data, which can be called “pattern coding data”. Besides recognising objects recognition of movement patterns is known as well. Restrictively a pattern recognition device according to the invention is a computer system having at least one detection means, which is suitable to detect goods and/or transportation means and/or movement of goods and transportation means independently and/or related to each other by means of pattern recognition in such way that the goods and/or the transportation means and/or their movement are identified.

The implementation of the method by the user of a retail store requires an embodiment, which accommodates needs of the user regarding protection of privacy, individual adaptation of motivators and parameters as well as fault tolerance.

Anonymising the user without loss of statistically analysable data is for example possible by the fact that the computer system as a consequence of the first detection process assigns the mobile communication device and the transportation means to one another, but terminates this assignment as a consequence of the second and third detection processes such that the data identifying the mobile communication device are substituted by serial numbers. Identification of a user therefore happens by means of identification of his mobile communication device only during shopping, making at least the first motivator effective, and restores privacy completely with ending of the method, making at least the first motivator ineffective.

An individual adaptation of motivators may for example be achieved by allowing the user to select from a multitude of motivators. The user may for example decide for the use of a deposit value, whereas another user may be willing to accept advertisement or interaction used as a motivator.

Considering varying skills of users, varying properties of mobile communication devices and possibly choices regarding identification means used for carrying out the detection processes, letting the user set parameters of the implementation of the method may be sensible.

Embodiments and individual settings achieving a high level fault tolerance are particularly noteworthy. Users of retail stores are not trained operators but private persons of varying age having varying abilities and habits. In terms of general user-friendliness every user should be permitted to make occasional mistakes in carrying out the method without having to bear unreasonable disadvantage hereby and without such mistakes affecting feasibility of the method to be carried out by following users. The method achieves feasibility of being repeated by the fact that each implementation of the method is independent from previous and following implementation. Generation of data of ordered pairs by the second and third detection processes achieves an information yield which enables the computer system to replace faulty data generated by faulty implementation of the method with correct data generated by a then following correct implementation of the method. The information yield moreover enables the computer system to detect more and more transportation means during repeated implementation of the method and calculate their position in stacks. This means that starting from completely unsorted stacks, as exist when transportation means are newly delivered to a retail store or have been cleaned and maintained, repeated implementation of the method generates information regarding the actual positions of transportation means in stacks.

This high level fault tolerance which is inherent to the method anyway can be developed user-friendly by certain settings.

For example it can be advantageous if during carrying out the first detection process on a transportation means using a multitude of mobile communication devices of a multitude of users, the identifiers of this multitude of mobile communication devices are assigned to the identifier of the transportation means and that as a consequence of the second and third detection processes being carried out with one or more mobile communication devices these assignments are all canceled. This embodiment supports in particular use of transportation means by a group of users, whereby motivators can become effective and can become ineffective for all members of the group.

Furthermore it is advantageous if in case of carrying out the first detection process on a transportation means using a first mobile communication device of a first user and carrying out the second and third detection processes on the same transportation means using a second mobile communication device of a second user which is not correlated with the first mobile communication device, the assignment to one another of the transportation means and the first mobile communication device is terminated by the second and third detection processes and that optionally no assignment to one another of the transportation means and the second mobile communication device is generated. This helps in particular to correct mistakes of a first user by a second user, with no disadvantage arising for the first user.

In order to map the respective status of use as well as application mistakes and fault correction to a software, it is sensible to differentiate between two status of use, wherein the first status of use is the status of a transportation means being in use and wherein the second status of use is the status of a transportation means not being in use. The differentiation of additional status of use is expedient for differentiating between a new transportation means which has not been used before and a transportation means already put in use, the differentiation between a transportation means having been lost and a transportation means not having been lost, and the differentiation between a transportation means having a known status of use and a transportation means having an unknown status of use. Linking of identifiers of transportation means with data coding status of use as well as changes of status of use as a consequence of carrying out the first detection process as well as the second and third detection processes enables mapping of cases relevant in practice. In order to change data coding status of use, additional data sources, in particular location and time data can be used. The respective specific form of these possibilities can be freely chosen according to the needs for the use location, the user and the retailers.

The advantage of mapping to a software the status of use of a new transportation means which has not been used before consists in that no gathering of data of transportation means in stacks is necessary when retail stores are equipped with transportation means. It is sufficient, according to common practice, to provide the transportation means in arbitrary order.

In order to carry out the method transportation means need to be equipped with at least one identification means intended for being correlated with a mobile communication device and for this purpose being detected by the mobile communication device. Since not all mobile communication devices have the same technical capabilities to detect an identification means, equipping transportation means with several identification means serving as options may be sensible. For example it can be made possible in this way to detect a transponder with an NFC smartphone, a QR code with data glasses, or a barcode with a smartphone having a barcode scanner.

Similarly price detection means need to be designed in such way that they are suitable for detection of identification means located on transportation means. This concerns device functions of a handheld scanner just as aspects of software technology.

The at least one identification means may be located at an arbitrary place of the transportation means. It is particularly advantageous if the identification means is located
on the push handle of the transportation means and/or
above the basket of a transportation means having a basket and/or
behind the child seat and in front of the basket front wall of a transportation means equipped with a basket and/or
on a tray for a mobile communication device.

A tray advantageously allows a continuous detection of the identification means by the mobile communication device located on the tray as well as a fixed position of the mobile communication device relating to the transportation means. This fixed location makes it easier to detect goods and movement of goods relating to the transportation means and thus by the fourth and fifth detection processes.

The identification means of the transportation means may be formed with a changeable card. This has the advantage that a standard card format, as is state of art for example in case of credit cards, can be used. An identification means in a standard format can be made in an efficient production process and cost-effectively with a barcode and/or a QR code and/or with a transponder. In particular by means of adhesive technology, optionally also by other means, the identification means can be connected to the transportation means in such way that the identification means is destroyed or modified if removed.

Furthermore it is advantageous if, being triggered by the detection of identification means, the price detection means is suitable by means of software technology to control device functions of the mobile communication device and to autonomously set up a data connection to a payment processing device intended for this purpose and optionally to terminate it again. Thereby it can be avoided that the user of a retail store has to elaborately set up and terminate the data connections by a user interface. Thus the optional credit of a deposit value or effectiveness of other motivators can be achieved solely by detection of the identification means of the transportation means and of an identification means located at the return point, which preferably is located on another transportation means, without expecting additional activities from the user.

Furthermore it is advantageous if the identification means of the transportation means is suitable to make available an application software intended for supporting the method to the mobile communication device, whereby the identification means carries a saved application software itself and/or a download link for the software and/or another software for automatically starting the download of the application software and/or a key needed for executing the application software. A user, having a mobile communication device which does not yet have an application software supporting the method, can in this way straightforwardly, by detection of the identification means of the transportation means with the mobile communication device, obtain the application software and install it on the mobile communication device. It is possible right during the installation or as a consequence of installation to transmit data for identifying the user and/or his mobile communication device, for example name, address, customer code, telephone number of the mobile communication device, credit card number, and the like, from the mobile communication device to the retail store and store them in a database of the retail store.

The invention stipulates carrying out a first, second and third detection process, the necessary number of detection processes for carrying out the method being described by this. Equivalent solutions using additional detection processes and process steps are captured by the invention as well. For example more than one identification means located at the return point may be detected due to range of the detection and arrangement of the identification means and it may be stipulated that the first detection process is carried out not only in the process of borrowing, but again when paying goods.

1. A method for hiring out a transportation means suitable for transporting goods, in which, at a return point, at least one transportation means is provided for use and subsequent return, each transportation means having an identification means, the user of a transportation means carrying with him a mobile communication device, the method using at least one motivator which is intended to impart to the user that the return of the transportation means used is advantageous, wherein, before return of the transportation means to the return site, the mobile communication device and the transportation means are associated by using the identification means in a first detection process and identifiers of the mobile communication device and the transportation means, which are assigned to one another, are stored by making use of at least one computer system, and wherein, upon return of the transportation means, a second detection process is carried out and the data obtained by the two detection processes are at least used by the at least one computer system to allow the use of the at least one motivator,
wherein a third detection process is carried out,
that the second and the third detection processes are carried out exclusively by the mobile communication device,
that the second detection process is carried out on the returned transportation means and the third detection process is carried out on an identification means located at the return point, wherein
the two detection processes can also be carried out in reverse order, and
that the assignment of the mobile communication device and the transportation means is terminated by the combination of the second and the third detection process, using at least one computer system.

2. The method as claimed in claim 1, wherein as a consequence of the carried out first detection process a wireless data connection is set up autonomously by the mobile communication device to a payment processing device and as a consequence of the carried out second and third detection processes is terminated either by the mobile communication device or the payment processing device or the at least one computer system.

3. The method as claimed in claim 1, wherein caused by the second and third detection processes and using a data connection between the mobile communication device and the at least one computer system an identifier of the transportation means and either the identifier of another transportation means or the identifier of an identification means located at the return point is being transmitted, that the at least one computer system checks the transmitted identifiers using inventory data relating to transportation means located at at least one return point and that the computer system makes ineffective a previously effective motivator if during checking one of the two identifiers were found in the inventory data and the respective other identifier was not found in the inventory data.

4. The method as claimed in claim 1, wherein as a consequence of the carried out second and third detection processes data of an ordered pair, consisting of the returned transportation means and a transportation means located at the return point, into which the returned transportation means is stacked, are created.

5. The method as claimed in claim 1, wherein as a consequence of the carried out second and third detection processes inventory data of transportation means located at at least one return point are updated such that the computer system can distinguish between a transportation means being returned and a transportation means being located at the return point.

6. The method as claimed in claim 1, wherein the second and third detection processes are carried out on the identification means of the returned transportation means, whereby using location data and/or inventory data of transportation means located at at least one return point are being determined, wherein optionally the user of the mobile communications device is requested by means of a user interface to report or confirm the starting of a row, and wherein inventory data are updated by data coding the start of a row.

7. The method as claimed in claim 1, wherein the computer system causes the ineffectiveness of a previously effective motivator only if there is no undercutting of a minimum number of transportation means and/or no exceeding of a maximum number of transportation means in a row of stacked transportation means having been subjected to the second and third detection processes.

8. The method as claimed in claim 1, wherein by the first and/or second and/or third detection process transmittal of location data and/or time data of the mobile communication device to the computer system are caused and/or terminated.

9. The method as claimed in claim 1, wherein as a consequence of carrying out the first detection process, a transportation means is detected as lost by the computer system if location data transmitted by the mobile communication device to the computer system do not the match intended use location, and that the computer system, in case of non-matching location data, sends a message to the mobile communication device and communicates which use location is intended for the transportation means.

10. The method as claimed in claim 1, wherein with the mobile communication device and the transportation means a goods receiving device is formed such that the mobile communication device detects goods and movement of goods relating to the transportation means and wherein the system of the goods receiving device is dissolved by the second and third detection processes.

11. The method as claimed in claim 1, wherein starting with or during the first detection process, the mobile communication device continuously detects the transportation means, that during the continuous detection the mobile communication device maintains a wireless data connection to the payment processing device, thereby a wireless controllable payment means of the customer being detected by the payment processing device, and that when taking or returning goods the taking and returning action is detected by the goods receiving device, which is formed with the mobile communication device and the transportation means, in such way that the update of a monetary value of the payment means is caused.

12. The method as claimed in claim 1, wherein caused by the second the third detection processes an AR system, which supports or enables purchase of goods, is being deactivated.

13. The method as claimed in claim 1, wherein after the first detection process and before the second and third detection processes the mobile communication device detects with a fourth detection process goods and with a fifth detection process movement of goods relating to the transportation means, wherein by the fifth detection process at least one movement pattern is detected, that the debit of the goods price using a payment means of the customer takes place and wherein by the first detection process the fourth and fifth detection processes are made possible and wherein by the second and third detection processes the fourth and fifth detection processes are made impossible.

14. The method as claimed in claim 1, wherein, triggered by the first detection process and during the shopping process, data relating to the shopping process and/or the purchased goods are stored in the mobile communication device and in the process are locked against transmittal and that by the second and third detection processes the locking is terminated and transmittal of the data using a data connection is made possible.

15. The method as claimed in claim 1, wherein as a consequence of the first detection process a computer system of the retail store and a computer system of the mobile communication device interact in such way that components, data, and computing power of the respective other system are accessed, in particular the computer system of the retail store accessing the camera of the mobile communication device and/or a payment means, which is present in the mobile communication device, as well as the mobile communication device accessing data and computing power of the computer system of the retail store, wherein the interaction is deactivated by the second and third detection processes.

16. The method as claimed in claim 1, wherein, using a deposit value as motivator, debits and credits of deposit values are saved to an account made with means of software in the mobile communication device until, using the fifth wireless data connection between the mobile communication device and a payment processing device, data of a deposit value or of deposit values are transmitted one by one, as a sum, or as a balance to the payment processing device and a deposit value or deposit values or the balance of several deposit value debits and credits are debited or credited to the customer by the payment processing device.

17. The method as claimed in claim 1, wherein the detection of an identification means located on a transportation means is carried out by a price detection means, wherein the price detection means is a software installed on the mobile communication device.

18. The method as claimed in claim 1, wherein , using a software key as motivator, by the first detection process a software key is generated, that with the software key a security set up is activated in such way that access to the retail store or a space section of the retail store is granted to the user, and that the key at latest is deleted by the second and third detection processes.

19. The method as claimed in claim 1, wherein the first detection process is carried out with a first mobile communication device and the second and the third detection processes are carried out with a second mobile communication device and that identifiers of the first and second mobile communication device and the transportation means are associated to one another using the computer system.

20. The method as claimed in claim 1, wherein, as a consequence of the first detection process, at least one motivator becomes effective and that the at least one motivator is formed by
a deposit value and/or
a reward and/or
a computer system formed with the mobile communication device and being intended for use during shopping and/or
by stored data available to the user and intended for economic exploitation by the user and/or
by update of a user interface of the mobile communication device as a consequence of the carried out first detection process such that data relating to the intended use of the transportation means are made available to the user.

21. The method as claimed in claim 1, wherein, as a consequence of the two subsequent detection processes, at least one motivator becomes ineffective and that the at least one motivator is formed by
a deposit value and/or
a reward and/or
a computer system formed with the mobile communication device and being intended for use during shopping and/or
by stored data available to the user and intended for economic exploitation by the user and/or
by update of a user interface of the mobile communication device as a consequence of the carried out first detection process such that data relating to the intended use of the transportation means are made available to the user.

22. The method as claimed in claim 20, wherein using a user interface effectiveness or ineffectiveness of a motivator is displayed to the user.

23. The method as claimed in claim 1, wherein when carrying out the second and third detection processes, the user actively carries out only the second or the third detection process and that the carried out detection process automatically causes the respective other detection process to be carried out.

24. The method as claimed in claim 1, wherein a motivator becomes ineffective only if the second and third detection processes have been carried out simultaneously or within a pre-set period of time.

25. The method as claimed in claim 1, wherein a motivator becomes ineffective only if goods detected by a price detection means are considered to be paid and optionally if a borrowed price detection means is considered to have been returned.

26. The method as claimed in claim 1, wherein only by detection of a transportation means and/or by a motivator becoming effective and/or by saving of data relating to a deposit value stored in a price detection means, an operation modus for detection of goods prices and/or for payment of goods is produced and that this operation modus is terminated at latest by the second and third detection processes.

27. The method as claimed in claim 1, wherein the ineffectiveness of a previously effective motivator is being caused only if the transportation means detected during the first detection process is being detected again during the second detection process.

28. The method as claimed in claim 1, wherein the motivators are different for individual customers.

29. The method as claimed in claim 1, wherein data generated by carrying out the method are saved to a computer system and kept ready to be analysed.

30. The method as claimed in claim 1, wherein, using a wireless data connection, the mobile communication device receives data from a pattern recognition device and/or sends data generated by the mobile communication device and supporting the pattern recognition device to at least one pattern recognition device, wherein optionally a user interface of the mobile communication device is updated.

31. The method as claimed in claim 1, wherein during carrying out the first detection process on a transportation means using a multitude of mobile communication devices of a multitude of users, the identifiers of this multitude of mobile communication devices are assigned to the identifier of the one transportation means and that as a consequence of the second and third detection processes being carried out with one of the mobile communication devices these assignments are all terminated.

32. The method as claimed in claim 1, wherein in case of carrying out the first detection process on a transportation means using a first mobile communication device of a first user and carrying out the second and third detection processes on the same transportation means using a second mobile communication device of a second user which is not correlated with the first mobile communication device, the assignment to one another of the transportation means and the first mobile communication device is terminated by the second and third detection processes and that optionally no assignment to one another of the transportation means and the second mobile communication device is generated.

33. The transportation means for carrying out the method as claimed in claim 1, wherein the transportation means is equipped with at least one identification means suitable for being correlated with a mobile communication device for a motivator to become effective and ineffective and for this purpose being detected by the mobile communication device, wherein the at least one motivator is formed by
a deposit value and/or
a reward and/or
a computer system formed with the mobile communication device and being intended for use during shopping and/or
by stored data available to the user and intended for economic exploitation by the user and/or
by update of a user interface of the mobile communication device as a consequence of the carried out first detection process such that data relating to the intended use of the transportation means are made available to the user.

34. The transportation means as claimed in claim 33, wherein the transportation means is equipped with at least two different identification means.

35. The transportation means as claimed in claim 33, wherein the identification means is located
on the push handle of the transportation means and/or
above the basket of a transportation means having a basket and/or
behind the child seat and in front of the basket front wall of a transportation means equipped with a basket and/or
on a tray for a mobile communication device.

36. The transportation means as claimed in claim 33, wherein the identification means of the transportation means is formed by a changeable card.

37. The transportation means as claimed in claim 33, wherein the identification means of the transportation means has a barcode and/or a QR code and/or a transponder.

38. The transportation means as claimed in claim 33, wherein the identification means is connected to the transportation means in such way that the identification means is destroyed or modified if removed.

39. The transportation means as claimed in claim 33, wherein the identification means of the transportation means is suitable to make available an application software intended for supporting the method to the mobile communication device, wherein the identification means carries a saved application software itself and/or a download link for the software and/or another software for automatically starting the download of the application software and/or a key needed for executing the application software.

40. The transportation means as claimed in claim 33, wherein in case of a multitude of transportation means being part of a stack located at the return point, for each transportation means located at the return point and being part of the stack, the spacially next identification means located at the return point is located on a transportation means which is spacially next within the stack.

41. The transportation means as claimed in claim 40, wherein at the return point all identification means intended for the two subsequent detection processes are located at transportation means being part of the stack.
